(19) United States
(12) Patent Application Publication
(10) Pub. No.: US 2009/0277884 A1
(43) Pub. Date: Nov. 12, 2009

(54) SURFACE MODIFICATION METHOD

(75) Inventors: Yoshiyuki UNO, Okayama-shi (JP); Yasuhiro Okamoto, Okayama-shi (JP); Tetsuomi Mohri, Himeji-shi (JP); Yuji Tanaka, Okayama-shi (JP); Motoki Kakui, Yokohama-shi (JP); Kazuo Nakamae, Yokohama-shi (JP)

Correspondence Address: VENABLE LLP, P.O. BOX 34385, WASHINGTON, DC, 20043-9998, US

(73) Assignees: Yoshiyuki Uno, Okayama-shi (JP); Yasuhiro Okamoto, Okayama-shi (JP); Tetsuomi Mohri, Himeji (JP); Sumitomo Electric Industries, Ltd., Osaka-shi (JP)

(21) Appl. No.: 12/392,164

(22) Filed: Feb. 25, 2009

(30) Foreign Application Priority Data
Feb. 25, 2008 (JP) P2008-043187

(51) Int. Cl. B23K 26/00; B23K 26/12

(52) U.S. Cl. 219/121.61

(57) ABSTRACT

The present invention relates to a surface modification method allowing the surface of a subject to be more effectively modified. In a pulsed-laser device suitable for use in this surface modification method, a semiconductor laser light source and a modulator constitute a seed light source. The seed light output from the seed light source is amplified by fibers for optical amplification, and the amplified light constitutes output from the pulsed-laser device. The pulsed-laser device allows the pulse width and repetition frequency of the output pulsed-laser light to be varied independently of each other. The pulse width of the pulsed-laser light output from the pulsed-laser device is preferably not more than 10 ns, and the repetition frequency is preferably at least 50 kHz.

### BACKGROUND OF THE INVENTION

1. Field of the Invention

The present invention relates to a method of modifying the surface of a work piece by irradiating the work piece with laser light.

2. Related Background Art

Techniques for modifying the surface of a work piece by irradiating the work piece with laser light are well known. In the surface modification method described in Japanese Patent Application Laid-Open No. 2006-231353 (Document 1), for example, the surface of a work piece is modified by irradiating the work piece with an ultrashort pulsed-laser beam and scanning the locations that are irradiated. Surface modification also includes the modification of properties such as hydrophilicity, water repellency, electromagnetic waves, sound waves, and electrical charge.

In the surface modification described in Document 1 above, the work piece is irradiated with an ultrashort pulsed-laser beam, specifically, an ultrashort pulsed-laser beam with a pulse width in the range of 150 fs to 3 ps. The pulsed-laser light also has an extremely low repetition frequency of 1 kHz. The surface of the work piece is modified through the formation of microstructures within spots irradiated by the laser light.

### SUMMARY OF THE INVENTION

The present inventors have examined the conventional surface modification methods, and as a result, have discovered the following problems.

As a result of detailed research on conventional methods of surface modification, the inventors found the following.

That is, in the surface modification method described in Document 1 above, the pulsed-laser light repetition frequency is very low and the pulse width is very narrow. This has resulted in poor and impractical surface modification throughput. Silicon oxides and fluororesins are also the only specific examples of work pieces targeted for surface modification in Document 1. As metal work pieces require pulse energy of a certain magnitude, the pulse width of the pulsed-laser light is preferably not too short.

Many materials such as alloys for molds are in need of surface modification. For that purpose, a pulsed-laser light capable of high speed scanning would require no mask and would result in equipment that weighs less, which could be especially practical in the field of ever smaller and more versatile electronics. In order to produce pulsed light, methods such as Q-switching and mode locking have been proposed for gas laser light sources and solid laser light sources, but none can provide light energy or repetition frequency suitable for surface modification.

The present invention has been developed to eliminate the problems described above. It is an object of the present invention to provide a method allowing more effective surface modification of work pieces.

The surface modification method of the present invention improves at least one of hydrophilicity, water repellency, corrosion resistance, abrasion resistance, and surface roughness of a work piece through the irradiation of the work piece with pulsed-laser light output from a pulsed-laser device. The pulsed-laser device characteristically allows the pulse width and repetition frequency of the pulsed-laser light that is to be output to be adjusted independently of each other, and independently adjusts the pulse width and repetition frequency so that the “fluence per pulse” (referred to below simply as “fluence”) of the pulsed-laser light used to irradiate the work piece is within the range of 5 to 12 J/cm². In this way, the pulsed-laser light is directed onto the work piece to modify the surface of the work piece, thereby resulting in visible modification effects and allowing discoloration to be controlled. The pulsed-laser light pulse width and repetition frequency can be controlled to desired levels independently of each other by modifying the conditions for controlling Q-switching in a laser resonator, for example.

The surface of a work piece cannot be modified with a pulsed-laser light fluence lower than 5 J/cm². A pulsed-laser light fluence greater than 12 J/cm², on the other hand, will result in discoloration of the work piece surface. The fluence of the pulsed-laser light is therefore preferably set within a predetermined range of 5 to 12 J/cm². To ensure that the work piece surface will be modified, the fluence of the pulsed-laser light is more preferably set within the range of 10 to 12 J/cm².

In the surface modification method of the present invention, the pulse width of the pulsed-laser light output from the pulsed-laser device is preferably not more than 10 ns. This will allow discoloration to be even more effectively controlled.

In the surface modification method of the present invention, the repetition frequency of the pulsed-laser light output from the pulsed-laser device is preferably at least 50 kHz. This will enable higher throughput modification of the work piece surface.

In the surface modification method of the present invention, the pulsed-laser device will preferably include an optical amplifier that is equipped with fibers for optical amplification. A directly modulated semiconductor laser light source may also be included as a pulsed-laser device. All of these will be beneficial in bringing about a pulsed-laser device permitting the output of pulsed-laser light having a high repetition frequency.

In the surface modification method of the present invention, the work piece will preferably be set up in air or a nitrogen gas atmosphere when irradiated with the pulsed-laser light. A work piece set up in such an atmosphere is irradiated with pulsed-laser light from the pulsed-laser device so that the work piece surface will be modified, allowing the hydrophilicity on the work piece surface to be improved. On the other hand, the work piece may also be set up in a compressed air atmosphere when irradiated with pulsed-laser light. A work piece set up in such an atmosphere is irradiated with pulsed-laser light from the pulsed-laser device so that the work piece surface will be modified, allowing the water repellency on the work piece surface to be improved.

Work pieces include ferrous materials that are suitable for molds and the like, and at least the surface of the work pieces will preferably be the ferrous material SKD11 or STAVAX. These will be beneficial for post-treatment such as plating of modified surfaces.

### BRIEF DESCRIPTION OF THE DRAWINGS

FIG. 1 is a structural diagram of a pulsed-laser device suitable for use in the surface modification method of the invention;

FIG. 2 is a photograph showing the modification of the surface of SKD11 material;

FIGS. 3A and 3B are graphs of the relationship between the surface roughness of surface-modified SKD11 and scanning frequency;

FIG. 4 is a graph of the relationship between the corrosion resistance of surface-modified SKD11 and scanning frequency;

FIGS. 5A through 5D are photographs showing the modification of the surface of SKD11 material;

FIG. 6 illustrates a test system for testing the water repellency on a work piece surface;

FIG. 7 is a photograph showing the configuration of a water drop on the surface of SKD11 material;

FIG. 8 is a photograph showing the configuration of a water drop on the surface of SKD11 material;

FIG. 9 is a partial view of the structure of an SKD11 and STAVAX pulsed-laser light irradiation test;

FIGS. 10A and 10B show the results of the SKD11 and STAVAX pulsed-laser light irradiation test;

FIGS. 11A and 11B show the results of a test conducted in a nitrogen atmosphere;

FIGS. 12A and 12B show the results of a test conducted in air;

FIGS. 13A and 13B are photographs showing the configuration of a water drop on the surface of SKD11 material;

FIG. 14 illustrates a test system for testing the abrasion resistance of a work piece surface;

FIG. 15 is a graph of abrasion resistance test results that were obtained when a ball 93 made of SUJ2 was used; and

FIG. 16 is a graph of abrasion resistance test results that were obtained when a ball 93 made of polyethylene was used.

### DESCRIPTION OF THE PREFERRED EMBODIMENTS

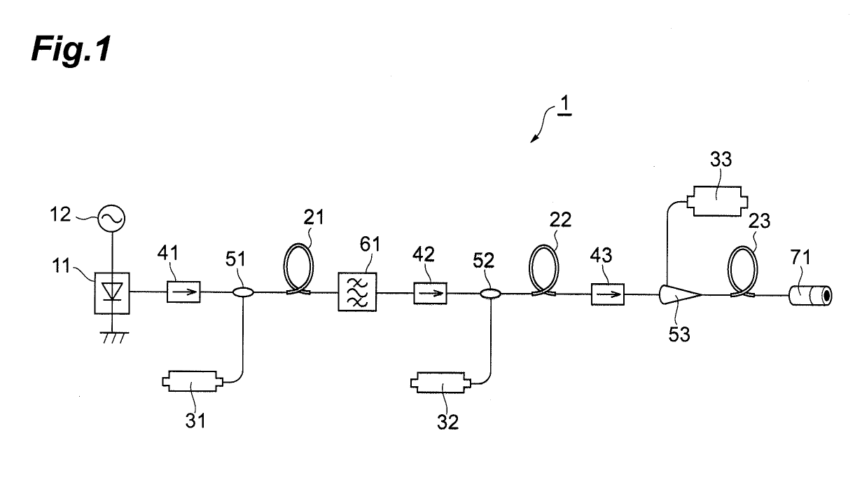

In the following, embodiments of surface modification method according to the present invention will be described in detail with reference to FIGS. 1, 2, 3A-3B, 4, 5A-5D, 6 to 9, 10A-13B, and 14-16. In the description of the drawings, identical or corresponding components are designated by the same reference numerals, and overlapping description is omitted.

FIG. 1 is a structural diagram of a pulsed-laser device 1 suitable for use in the surface modification method of the invention. The pulsed-laser device 1 shown in the figure is equipped with a semiconductor laser light source 11, modulator 12, fibers 21 through 23 for optical amplification, excitation light sources 31 through 33, isolators 41 through 43, couplers 51 and 52, combiner 53, band pass filter 61, and collimator 71. The pulsed-laser device 1 allows the pulse width and repetition frequency of the output pulsed-laser light to be adjusted independently of each other. The pulse width of the pulsed-laser light output from the pulsed-laser device 1 is preferably not more than 10 ns, and the repetition frequency is preferably at least 50 kHz.

The semiconductor laser light source 11 and modulator 12 form a seed light source. The seed light output from the seed light source is amplified by the fibers 21 through 23 for optical amplification, and the amplified light is output from the pulsed-laser device 1. That is, the pulsed-laser device 1 has the structure of a MOPA (Master Oscillator Power Amplifier).

The semiconductor laser light source 11 is a 1060 nm wavelength Fabry-Perot semiconductor laser that is directly modulated on and off within the range of 0 to 200 mA by the modulator 12 so as to bring about a high repetition frequency of over 100 kHz and a constant pulse width independently of the repetition frequency. The fibers 21 through 23 for optical amplification each have gain in the 1060 nm wavelength region of the seed light emitted from the semiconductor laser light source 11. A high gain ranging over dozens of dB can be obtained with a solid laser light source such as YAG or YVO. The seed light is therefore preferably amplified by the optical amplification fibers 21 through 23 arranged in multiple steps.

The active medium for bringing about optical amplification will preferably have gain around a wavelength of 1060 nm, which is compatible with existing YAG laser light sources, and a power conversion efficiency such that the excitation light wavelength and the amplified light wavelength are close to each other. The element Yb is advantageous in this respect. In terms of the ability to obtain high gain as noted above, the optical amplification fibers 21 through 23 are preferably YbDF (Yb-doped fibers), which can be obtained through the addition of Yb to a quartz fiber optic core. The optical amplifier for amplifying the seed light output from the semiconductor laser light source 11 has a three-stage structure including the light amplification fibers 21 through 23.

In the first stage optical amplifier, the seed light output from the semiconductor light source 11 and input through the isolator 41 and coupler 51 into the optical amplification fiber 21 is amplified by the optical amplification fiber 21. The excitation light supplied from the excitation light source 31 through the coupler 51 to the optical amplification fiber 21 has a wavelength of 975 nm and 200 mW power. The optical amplification fiber 21 is a core excitation type of YbDF, with an unsaturated absorption coefficient of 240 dB/m at a wavelength of 975 nm, a length of 5 m, a core diameter of 6 μm, and an NA of about 0.12. The band pass filter 61 set up in the stage after the first optical amplifier is inserted in order to inhibit ASE light of wavelengths other than the light output from the seed light course, and the full width at half maximum is about 4 nm.

In the second stage optical amplifier, the light output from the band pass filter 61 and input through the isolator 42 and coupler 52 into the optical amplification fiber 22 is amplified by the optical amplification fiber 22. The excitation light supplied from the excitation light source 32 through the coupler 52 to the optical amplification fiber 22 has a wavelength of 975 nm and 200 mW power The optical amplification fiber 22 is a core excitation type of YbDF, with an unsaturated absorption coefficient of 240 dB/m at a wavelength of 975 nm, a length of 7 m, a core diameter of 6 μm, and an NA of about 0.12.

In the third stage optical amplifier, the light output from the second stage optical amplification fiber 22 and input through the isolator 43 and coupler 53 into the optical amplification fiber 23 is amplified by the optical amplification fiber 23, and the amplified light is output from the collimator 71 to the outside. The excitation light supplied from the excitation light source 33 through the coupler 53 to the optical amplification fiber 23 has a wavelength of 975 nm, and has 20 mW power based on the use of four 5 W excitation LDs. The optical amplification fiber 23 is a core excitation type of YbDF, with an unsaturated absorption coefficient of 1200 dB/m at a wavelength of 975 nm, a length of 4 m, a core diameter of 10 μm, and a core NA of about 0.08. The inner cladding of the optical amplification fiber 23 has a diameter of 125 μm and an NA of about 0.46.

In the surface modification method in this embodiment, the beam diameter (EPD) of the pulsed-laser light output from the pulsed-laser device 1 above is expanded to 8 mm, and the pulsed-laser light is then directed onto the work piece by a Galvano Scanner and fθ lens with a focal distance of 100 mm. At this time, the locations on the work piece being irradiated by the pulsed-laser light are scanned, and the fluence of the pulsed-laser light directed onto the work piece is set to within the range of 5 through 12 J/cm², so as to modify the work piece surface. The fluence of the pulsed-laser light is more preferably set within the range of 10 through 12 J/cm².

At this time, the work piece is irradiated with the pulsed-laser light while set up in air or a nitrogen gas atmosphere. The work piece surface is preferably modified in this way to enhance the surface hydrophilicity. The work piece may also be irradiated with the pulsed-laser light while set up in a compressed air atmosphere. In that case, the work piece surface can be modified to enhance the surface water repellency. The surface of an SKD11 material is preferably modified as the work piece to enhance the surface hydrophilicity. SKD11 is steel that has very good abrasion resistance and is commonly used as material for machining tools such as dies or gages.

An example involving the use of SDK11 as the work piece will be described below. The pulsed-laser light output from the pulsed-laser device 1 onto the surface of the SKD11 material had a spot diameter of 20 μm. The SKD11 material was set up in a nitrogen gas atmosphere to prevent the SKD11 material from oxidizing. The locations irradiated with pulsed-laser light were scanned at a rate of about 2 m/s to ensure virtually 0% overlap between each pulsed beam spot of pulsed-laser light on the surface of the SKD11 material. Too much overlap will cause the beam spots to overlap too much, resulting in the formation of burrs, and the overlap is therefore preferably kept as much as possible to not more than 50%.

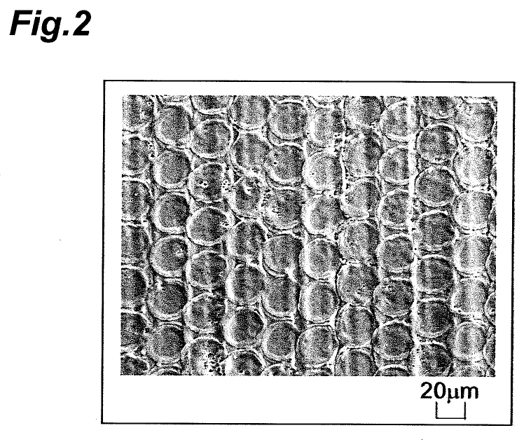

FIG. 2 is a photograph showing the modification of the surface of SKD11 material. In the example shown in FIG. 2, the pulsed-laser light directed onto the SKD11 has a mean power of 4.5 W, a pulse width of 10 ns, a repetition frequency of 100 kHz, and energy of about 40 μJ per pulse, with a fluence of 12.7 J/cm². In other examples, the pulsed-laser light directed onto the SKD11 has a mean power of 4.5 W, a pulse width of 2 ns, and repetition frequencies of 100 kHz, 200 kHz, and 500 kHz. At a pulse width of 2 ns and a repetition frequency of 100 kHz, the energy per pulse will be about 16 μJ. A fluence of 12 J/cm² or more may result in discoloration. However, the fluence may be 12 J/cm² or more when discoloration is not a matter of concern.

Some discoloration of the SKD11 surface may occur when the pulse width is set to 10 ns, but the surface of the SKD11 material will not become discolored when the pulse width is set to 2 ns. The effect of heat is considered a cause of discoloration. This is a phenomenon that is also dependent on pulse width in addition to fluence, and a pulse width not more than 10 ns is considered desirable.

A pulse width of 0.7 ns (pulse energy: 14 μJ; fluence: 4.5 J/cm²) was attempted for further improvement in relation to the effect of heat, but there was no evidence of machining, possibly because the fluence was too low. Despite the possibility that visible evidence of machining might begin at a pulse energy at or over the prevailing level of 20 kW, in view of the use of fiber optics, it would not be easy to achieve not less than this higher peak power due to the influence of nonlinear effects which may occur in the fibers.

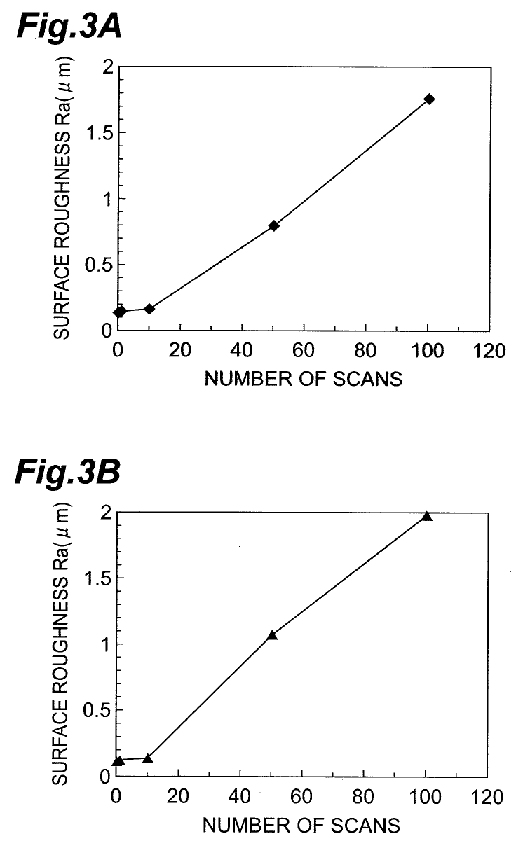

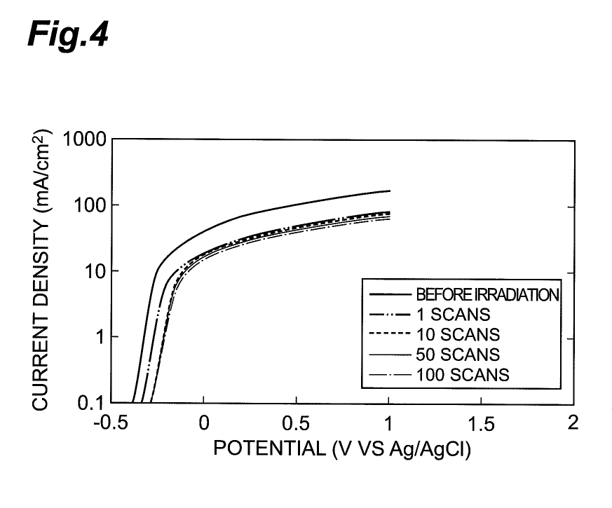

FIGS. 3A and 3B are graphs of the relationship between the surface roughness of surface-modified SKD11 and scanning frequency. Also, the fluence in FIGS. 3A and 3B is 12 J/cm². The vertical axis shows the two parameters Ra and Rz (Ra and Rz are based on the JIS-B-601 standards) which are used as indicators of surface roughness. As shown in FIGS. 3A and 3B, the greater the number of pulsed-laser light scans on the SKD11 material, the greater the surface roughness of the SKD11 material. FIG. 4 is a graph of the relationship between the corrosion resistance of the surface-modified SKD11 and scanning frequency. Specifically, this is an anode polarization curve for immediately after mechanical grinding (0 scans), 10 scans, and 100 scans. That is, the graphs show changes in the magnitude of current per unit area upon the application of voltage at a rate of 1 mV/s. The fluence is also 12 J/cm² in FIG. 4. As shown in FIG. 4, the greater the number of pulsed-laser light scans on the SKD11 material, the greater the corrosion resistance of the SKD11 material. As shown in FIG. 4, the greater the number of pulsed-laser light scans on the SKD11 material, the better the correlation of both the surface roughness and corrosion resistance relative to the number of scans. That is, the number of scans can be changed to control the surface conditions of the SKD11 material.

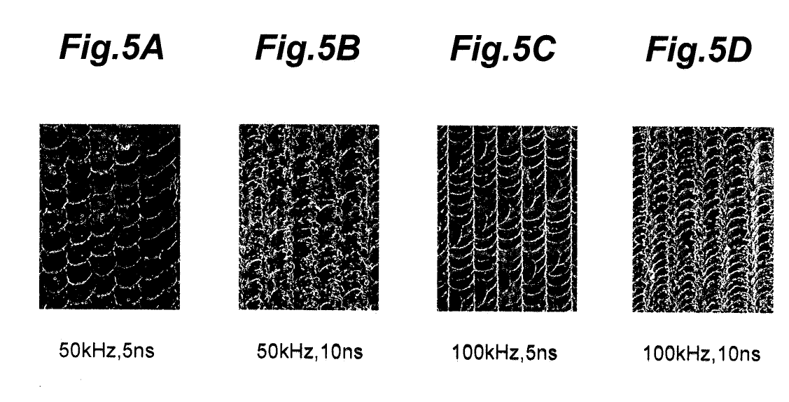

FIGS. 5A to 5D are photographs showing the modification of the surface of SKD11 material. In the examples shown in FIGS. 5A to 5D, the pulsed-laser light directed onto the SKD11 had a mean power of 5 W and was scanned at a rate of 1000 mm/s. In the example shown in FIG. 5A, the pulsed-laser light had a repetition frequency of 50 kHz and a pulse width of 5 ns. In the example shown in FIG. 5B, the pulsed-laser light had a repetition frequency of 50 kHz and a pulse width of 10 ns. In the example shown in FIG. 5C, the pulsed-laser light had a repetition frequency of 100 kHz and a pulse width of 5 ns. In the example shown in FIG. 5D, the pulsed-laser light had a repetition frequency of 100 kHz and a pulse width of 10 ns. As shown in FIGS. 5A to 5D, the modified surface conditions were changed in a variety of ways through combinations of pulse width and repetition frequency. That is, optimal surface conditions can be selected according to the type of plating material or the like. It is also possible to change the scanning direction to improve the friction coefficient in only a specific direction.

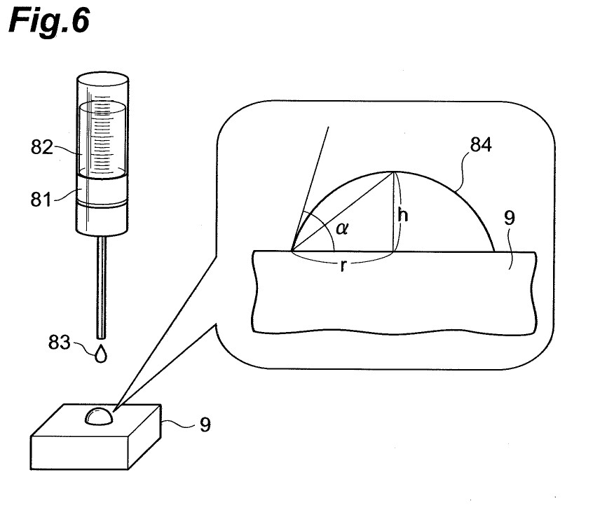

FIG. 6 illustrates a test system for testing the water repellency on a work piece surface. In this test system, a drop of water 82 contained in a syringe 81 is allowed to fall, in the form of a droplet 83 1 mm in diameter, from the tip of the needle of the syringe 81 onto the surface of a work piece 9. The height h and radius r of the droplet 84 which has fallen onto the surface of the work piece 9 corresponds to the surface water repellency of the work piece 9. The height h and radius r of the droplet 84 on the surface of the work piece 9 are measured to determine the value of parameter α (referred to below as “angle of contact”) based on the formula α=2 tan⁻¹ (h/r). The value for the angle of contact α indicates the surface water repellency of the work piece 9.

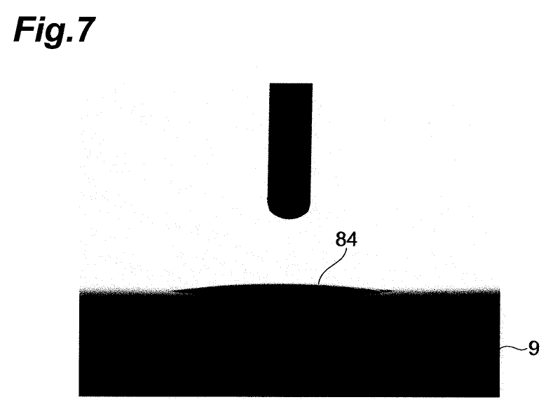

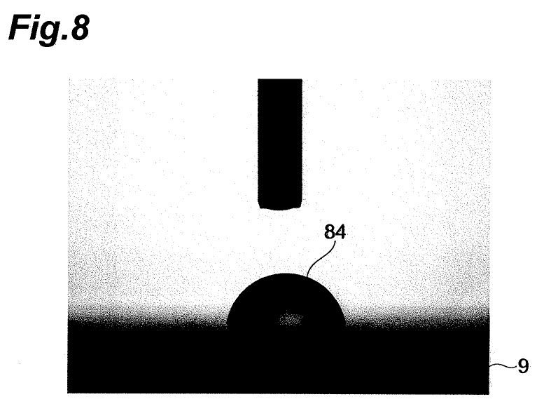

The angle of contact α is 77 degrees on the unmodified surface of the SKD11 material after being ground. By contrast, as shown in the photograph of FIG. 7, the angle of contact α is 9 degrees on the surface of the SKD11 material after a single scan at 0% spot overlap, a mean laser output of 4.5 W, and a pulse width of 10 ns in a nitrogen gas atmosphere. It is thus apparent that the surface hydrophilicity of the SKD11 material was dramatically improved and would be beneficial for plating processes and the like. On the other hand, the surface water repellency of the SKD11 can be improved, depending on the pulsed-laser light irradiation conditions, such as increasing the number of scans. That is, as shown in the photograph of FIG. 8, 100 scans under the above conditions resulted in an angle of contact α of 87 degrees.

The work piece is preferably a ferrous material in consideration of applications for molds or the like. Many types of ferrous materials, not just the SKD11 above, are suitable as mold materials, and their behavior will vary depending on their properties. A desirable example is STAVAX, which has better corrosion resistance and specularity than SKD11. The results of pulsed-laser light irradiation tests on SKD11 and STAVAX are given below.

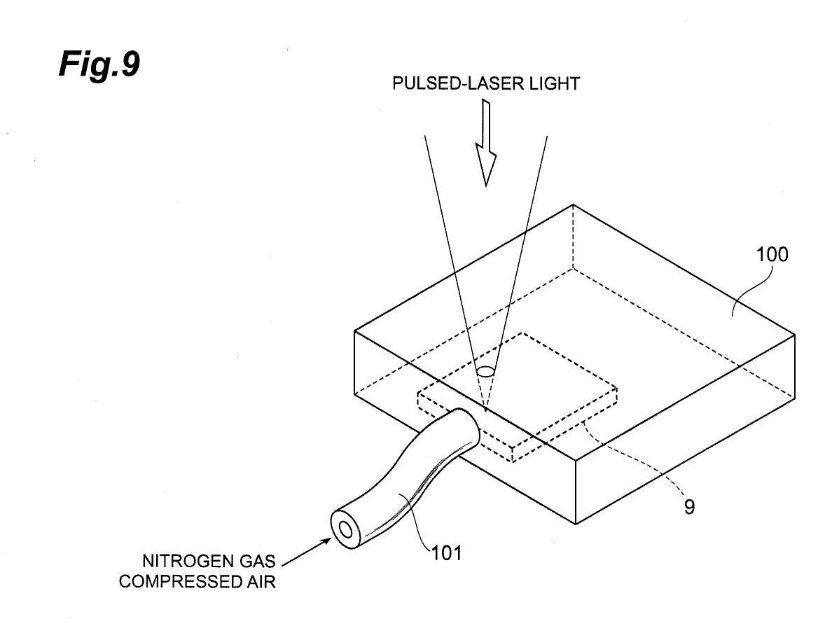

In the pulsed-laser light irradiation test, the SKD11 and STAVAX were set up in three atmospheres: nitrogen gas, compressed air, and air. As shown in FIG. 9, when the SKD11 and STAVAX were set up in a nitrogen gas or compressed air atmosphere, the working sample was placed in a case 100 having internal dimensions of 20 mm×72 mm×70 mm, the nitrogen gas or compressed air was injected through a tube 101 having in inside diameter of 2.5 mm into the case 100, and the pressure in the case 100 was held at 0.1 MPa.

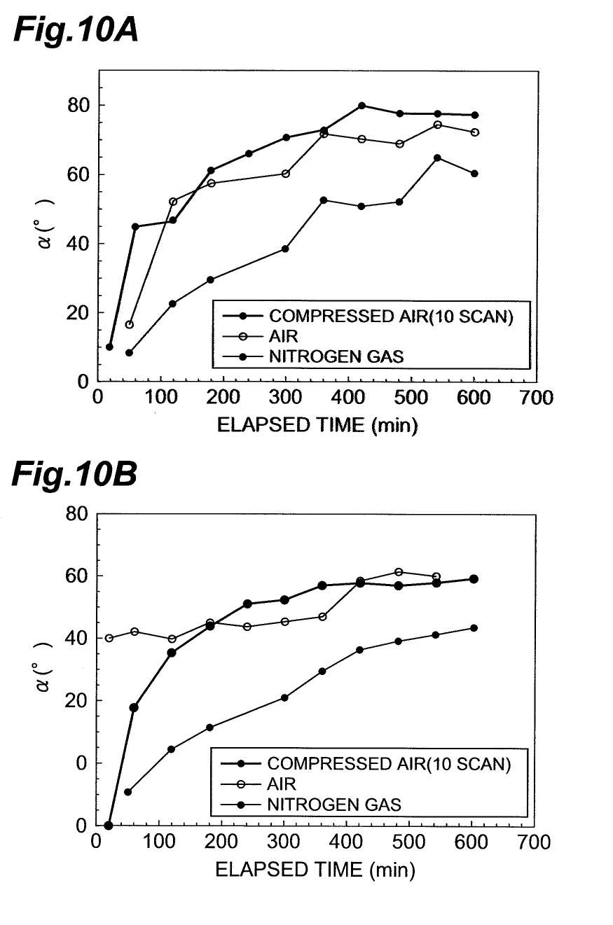

FIGS. 10A and 10B show the results that were obtained when SKD11 and STAVAX as the working samples were irradiated with pulsed-laser light. Specifically, the measured results are for water repellency on the modified surface of the working samples which had been irradiated with pulsed-laser light under conditions involving a repetition frequency of 100 kHz, a 0% spot overlap, and a single scan. FIG. 10A shows the measured results for SKD11, and FIG. 10B shows the measured results for STAVAX. In the graphs of FIGS. 10A and 10B, the vertical axis shows the angle of contact α(°) specified in FIG. 6, and the horizontal axis shows the time after the completion of the pulsed-laser light irradiation. The pulsed-laser light directed onto the working sample had a central wavelength of 1060 nm, a mean power of 5 W, and a pulse width of 10 nm.

As is apparent from FIGS. 10A and 10B, the hydrophilicity of both the SKD11 and STAVAX was highest in air, and the water repellency in compressed air was higher than in the nitrogen atmosphere. In addition, all the measured results revealed a unique phenomenon in which the water repellency increased over time after irradiation with pulsed-laser light. Far more hydrophilic surfaces are obtained after irradiation with pulsed-laser light.

The results in FIGS. 10A and 10B reveal that optimization of the time after irradiation, not to mention optimization of the conditions of pulsed-laser light irradiation, are important for controlling hydrophilicity or water repellency.

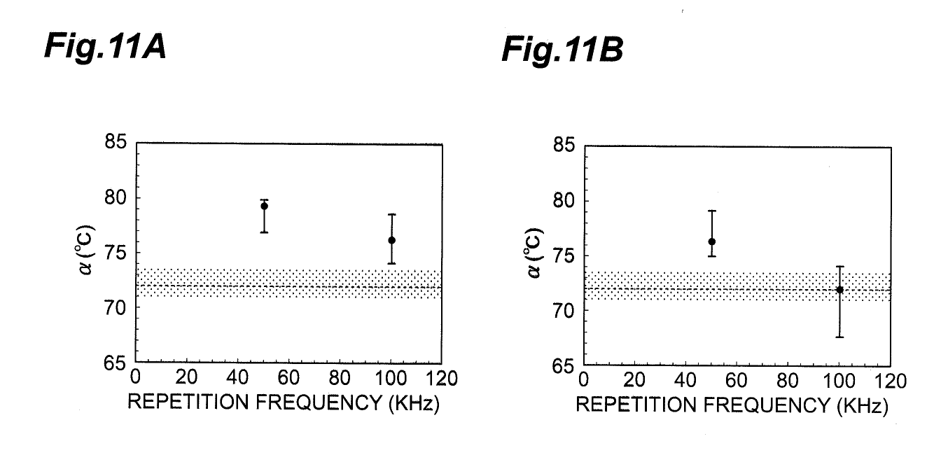

SKD11 was similarly tested with pulsed-laser light having a mean output power of 5 W, a repetition frequency of 50 kHz or 100 kHz, and a pulse width of 5 ns or 10 ns, with the laser light scanning direction parallel to the direction in which the work piece was ground, in a machining atmosphere of nitrogen or air. The test results are given in FIGS. 11A to 13B.

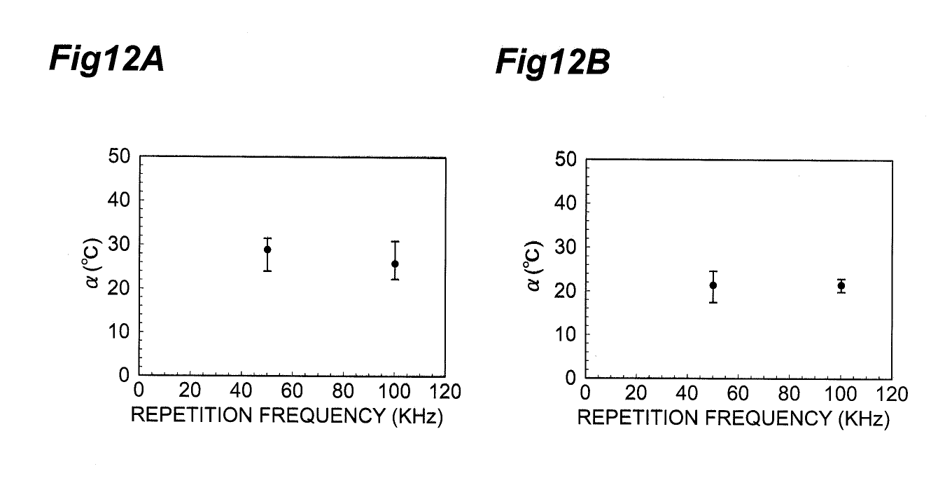

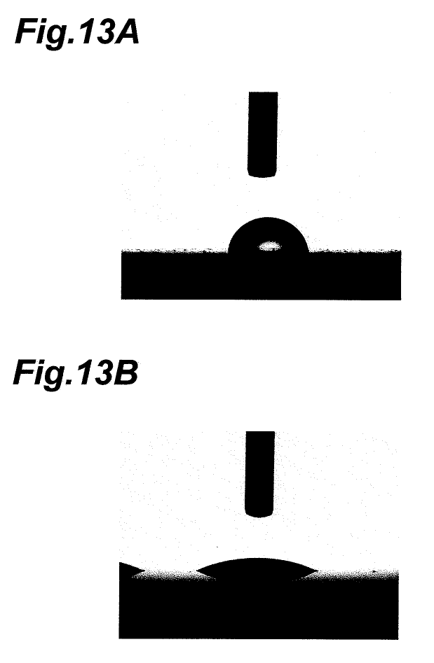

FIGS. 11A and 11B show the results of a test conducted in a nitrogen atmosphere. FIG. 11A shows the results that were obtained at a pulse width of 5 ns, and FIG. 11B shows the results that were obtained at a pulse width of 10 ns. FIGS. 12A and 12B show the results of a test conducted in air. FIG. 12A shows the results that were obtained at a pulse width of 5 ns, and FIG. 12B shows the results that were obtained at a pulse width of 10 ns. FIG. 13A is a photograph showing the configuration of a water drop on the surface of SKD11 material when tested in a nitrogen atmosphere, and FIG. 13B is a photograph showing the configuration of a water drop on the surface of SKD11 material when tested in air.

As shown in FIGS. 11A, 11B, and 13A, the results of the pulsed-laser light irradiation test conduced in a nitrogen atmosphere were generally the as the results which have already been discussed. In contrast, as shown in FIGS. 12A, 12B, and 13B, in air, the angle of contact α was smaller and the wettability was better. That is, wettability can be improved through pulsed-laser light irradiation in air.

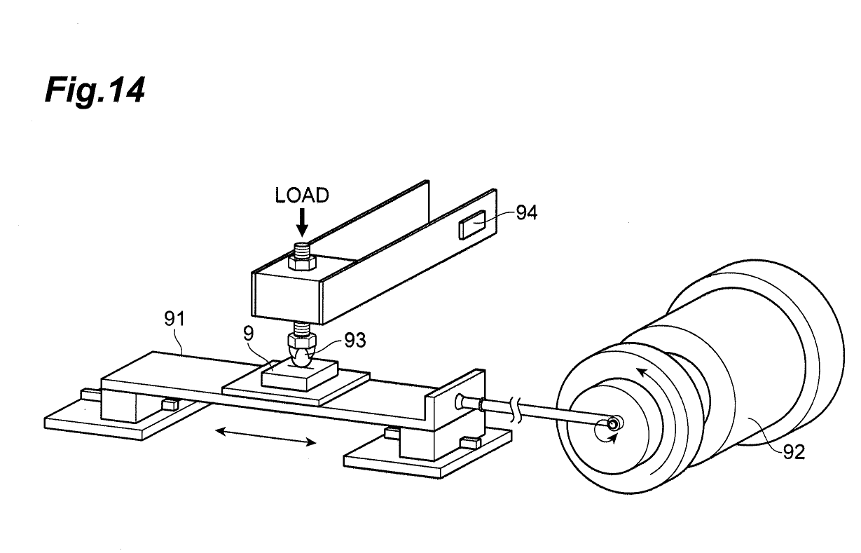

FIG. 14 illustrates a test system for testing the abrasion resistance of a work piece surface. In this test system, a stage 91 on which the work piece 9 had been placed was moved by a motor 92, a ball 93 was brought into contact and loaded on the work piece 9 on the stage 91, and the displacement of the ball 92 resulting from the movement of the work piece 9 was determined by a strain gage 94. The results obtained with the strain gage 94 indicate the abrasion resistance of the work piece 9 according to the material of the ball 93.

The SKD11 materials used for the work piece 9 had been scanned 1, 10, 50, or 100 times under conditions involving 0% spot overlap, a mean laser output of 4.5 W, and a pulse width of 10 ns in a nitrogen gas atmosphere. SUJ2 and polyethylene were each used as the material for the ball 93.

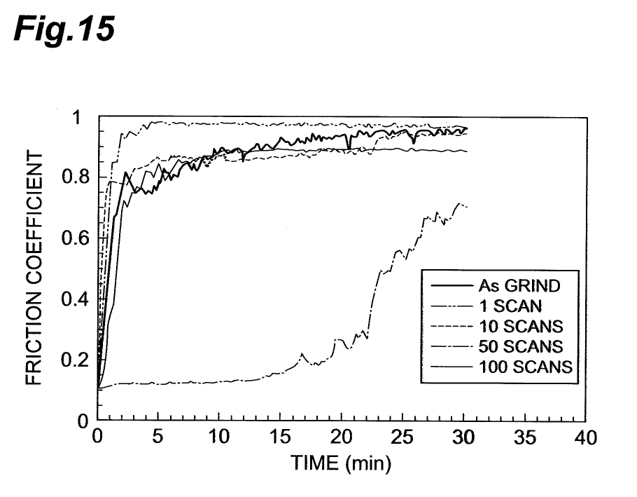

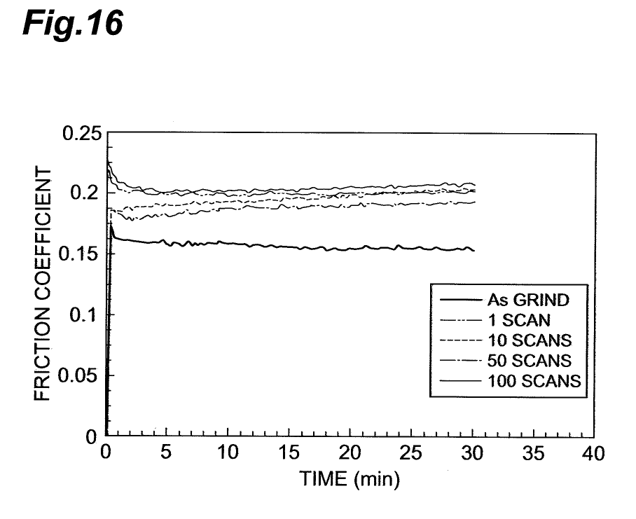

FIG. 15 is a graph of abrasion resistance test results that were obtained when a ball 93 made of SUJ2 was used. The fluence is also 12 J/cm² in FIG. 15. FIG. 16 is a graph of abrasion resistance test results that were obtained when a ball 93 made of polyethylene was used. In both cases, good results were obtained with 50 scans. It was thus determined that optimizing the number of scans is an effective way to improve abrasion resistance.

As noted above, the present invention allows the surface of a work piece to be more effectively modified.

What is claimed is:

1. A surface modification method of improving at least one of hydrophilicity, water repellency, corrosion resistance, abrasion resistance, and surface roughness of a work piece, by irradiating the work piece with pulsed-laser light, the method comprising the steps of:
preparing a pulsed-laser device allowing the pulse width and repetition frequency of the pulsed-laser light to be adjusted independently of each other;
adjusting independently the pulse width and repetition frequency of the pulsed-laser light so that a pulsed-laser light fluence is set within a predetermined range of 5 to 12 J/cm² in relation to the pulsed-laser device; and
allowing pulsed-laser light, in which the fluence has been set within the predetermined range, to be directed from the pulsed-laser device toward the work piece.

2. A surface modification method according to claim 1, wherein the fluence of the pulsed-laser light is set within the range of 10 to 12 J/cm².

3. A surface modification method according to claim 1, wherein the pulse width of the pulsed-laser light is not more than 10 ns.

4. A surface modification method according to claim 1, wherein the repetition frequency of the pulsed-laser light is at least 50 kHz.

5. A surface modification method according to claim 1, wherein the pulsed-laser device comprises an optical amplifier including fibers for optical amplification.

6. A surface modification method according to claim 1, wherein the pulsed-laser device comprises a directly modulated semiconductor laser light source.

7. A surface modification method according to claim 1, wherein the work piece is set up in air or a nitrogen gas atmosphere, and
wherein pulsed-laser light is directed from the pulsed-laser device toward the work piece so as to modify the surface of the work piece and improve the hydrophilicity of the surface of the work piece.

8. A surface modification method according to claim 1, wherein the work piece is set up in a compressed air atmosphere, and
wherein pulsed-laser light is directed from the pulsed-laser device toward the work piece so as to modify the surface of the work piece and improve the water repellency of the surface of the work piece.

9. A surface modification method according to claim 1, wherein a work piece that has been irradiated on the surface with pulsed-laser light is kept from any other treatment for at least 400 minutes after having been irradiated with the pulsed-laser light.

10. A surface modification method according to claim 1, wherein the work piece contains a ferrous material.

11. A surface modification method according to claim 10, wherein at least the surface region of the work piece is SKD11 or STAVAX.
